(19) United States
(12) Patent Application Publication
(10) Pub. No.: US 2007/0174473 A1
(43) Pub. Date: Jul. 26, 2007

(54) Method of broadband access device for controlling a dhcp relay user

(75) Inventors: Zhenfu Zhao, Shenzhen City (CN); Dong Wang, Shenzhen City (CN); Hua Li, Shenzhen City (CN)

Correspondence Address: BANNER & WITCOFF, LTD., 1100 13th STREET, N.W., SUITE 1200, WASHINGTON, DC, 20005-4051, US

(73) Assignee: ZTE Corporation, Shenzhen City (CN)

(21) Appl. No.: 10/585,095

(22) PCT Filed: Jun. 4, 2004
(86) PCT No.: PCT/CN04/00604

§ 371 Date: Mar. 2, 2007

(30) Foreign Application Priority Data
Dec. 31, 2003 (CN) 200310116094.0

(51) Int. Cl. G06F 15/16

(52) U.S. Cl. 709/230

(57) ABSTRACT

The present invention discloses a method of broadband access device for controlling a DHCP relay user, which method comprises modifying protocol fields in all of DHCP messages interacted between a DHCP relay and a DHCP client and a DHCP server during initiation phase of the DHCP interaction at Application Layer of TCP/IP protocol so that all of the DHCP messages interacted between the client and the server can pass through the DHCP relay. The present invention can easily control and manage the interaction between the DHCP client and the external DHCP server, vary the network parameters of the DHCP user and detecting the DHCP user online and so on according to the requirements of the user management strategy. Furthermore, the present invention only needs to process Application Layer of TCP/IP protocol to achieve the predetermined purpose of control management.

### TECHNICAL FIELDS OF THE INVENTION

The present invention relates to a broadband access network device which dynamically assigns IP addresses to DHCP (Dynamic Host Configuration Protocol) users by utilizing a DHCP relay in an Ethernet environment. The device obtains IP address for a client through an external DHCP server and needs to implement control and management of the process of address assignment to the DHCP users.

### BACKGROUND OF THE INVENTION

With the development of broadband network technology, many broadband access network devices, such as wireless AC (Access Controller), broadband AS (Access Server) and broadband access router, are emerged. Generally, these network devices have user access mode of DHCP+WEB PORTAL and the like. Wherein, in the broadband user access mode of DHCP+WEB PORTAL, IP address needs to be assigned to the accessed user and to be managed. In the current implementations, these broadband network access devices mostly provide a function of assigning dynamic IP address to an internal DHCP CLIENT by an external DHCP SERVER through the DHCP relay.

However, how to manage the DHCP relay user when the DHCP relay is enabled in the broadband access device is not taken into account in DHCP related protocols. For example, in DHCP protocol, broadcast interaction between the DHCP CLIENT and the external DHCP SERVER is performed through the DHCP relay, while unicast interaction is performed directly between the DHCP CLIENT and the external DHCP SERVER and need not be relayed by the DHCP relay disposed in Application Layer of TCP/IP protocol. It becomes a difficult problem that how to manage the DHCP relay user, i.e. how to enable the broadband access device to control and manage the interaction between the DHCP user and the external DHCP SERVER, vary the network parameters of the DHCP user, and detect the DHCP user online and so on. Currently, many methods used to handle the problem in the broadband access device supporting DHCP relay are identifying and classifying the DHCP data packets for individual and special processing at lower layer of TCP/IP (Transfer Control Protocol/Internet Protocol) protocol, such as data link layer. Such methods would require varying TCP/IP protocol stack or depending on related particular Hook Function provided by TCP/IP protocol stack to perform related special processing. Moreover, such methods cannot be implemented when source codes of TCP/IP protocol stack is unavailable or TCP/IP protocol stack does not provide the related particular Hook Function.

The solutions for solving the above problem in the prior art has not been found.

### SUMMARY OF THE INVENTION

An object of the present invention is to provide a method of broadband access device for controlling a DHCP relay user, which method can solve the problem that the control and management of the interaction between the DHCP client and the DHCP server are difficult to perform because the unicast interaction is performed directly between the DHCP client and the DHCP server and needs not the DHCP relay disposed in Application Layer of TCP/IP protocol.

To complete the above-mentioned object, the present invention provides a method of broadband access device for controlling a DHCP relay user to implement the control and management of interaction between a DHCP client and a DHCP server by the broadband access device, which method comprises modifying protocol fields in all of DHCP messages interacted between a DHCP relay and the DHCP client and the DHCP server during initiation phase of the DHCP interaction at Application Layer of TCP/IP protocol, so that all of the DHCP messages interacted between the client and the server can pass through the DHCP relay.

The method is characterized by the modifying further comprising following steps:

Step 1, after receiving any DHCP messages for request sent from the DHCP client to the DHCP server, the DHCP relay filling in fields associated with the DHCP relay in the DHCP message for request, so that any DHCP messages for response returned from the DHCP server to the DHCP client can pass through the relay;

Step 2, after receiving a first DHCP message for response returned from the DHCP server to the DHCP client, the DHCP relay extracting and storing DHCP server parameters in fields associated with the DHCP server in the first DHCP message for response, then replacing the DHCP server parameters with DHCP relay parameters of the DHCP relay and sending the first DHCP message for response to the DHCP client;

Step 3, the DHCP relay processing any received subsequent DHCP messages for response sent from the DHCP server to the DHCP client, determining whether the subsequent DHCP messages for response contains the fields associated with the DHCP sever, if not, sending the subsequent DHCP messages for response to the DHCP client directly, otherwise, replacing the DHCP server parameters in the fields with the DHCP relay parameters, and sending the subsequent DHCP messages for response to the DHCP client so that any subsequent DHCP messages for request sent from the DHCP client to the DHCP server can pass through the DHCP relay;

Step 4, the DHCP relay processing the subsequent DHCP messages for request, determining whether the subsequent DHCP messages for request contains the fields associated with the DHCP sever, if not, sending the subsequent DHCP messages for request to the DHCP server directly, otherwise, filling in the fields associated with the DHCP server with the DHCP server parameter stored in Step 2, and sending the subsequent DHCP messages for request to the DHCP server so that the subsequent DHCP messages for request can pass validity checking by the DHCP server.

The method is characterized by further comprising:

Step 5, the DHCP relay controlling and managing the interaction between the DHCP client and the DHCP server, varying network parameters of the DHCP client and detecting the DHCP client online according to requirements of user management strategy.

The method is characterized by in Step 1, for DHCPDISCOVER or DHCPREQUEST message sent from the DHCP client to the DHCP server, the DHCP relay filling in the fields associated with the DHCP relay with values, so that DHCPOFFER, DHCPACK or DHCPNAK response to the request from the DHCP server to the DHCP client can be sent to the DHCP relay.

The method is characterized by in Step 2, the DHCP relay receiving DHCPOFFER, DHCPACK or DHCPNAK response, extracting and storing the DHCP server parameters in DHCPOFFER, DHCPACK or DHCPNAK response, and replacing the DHCP server parameters with the DHCP relay parameters so that a unicast request to the DHCP server is still sent to the DHCP relay after the DHCP client has configured IP address.

The method is characterized by in Step 3, the DHCP relay receiving the subsequent DHCP messages for response, if the fields associated with the DHCP server are contained, replacing the values of the fields associated with the DHCP server with IP address of the DHCP relay.

The method is characterized by the subsequent DHCP messages for response is DHCPACK message in Dynamical Host Configuration Protocol.

The method is characterized by the subsequent DHCP messages for request is DHCPREQUEST message, DHCPINFORM message or DHCPRELEASE message in Dynamical Host Configuration Protocol.

### BRIEF DESCRIPTION OF THE DRAWINGS

FIG. 1 shows a flow chart of modifying the related fields in the DHCP message in a method according to the present invention;

FIG. 2 shows a normal time sequence diagram of the DHCP CLIENT obtaining the properties of network in the present invention;

FIG. 3 shows a diagram of an ISP access network implementing the present invention.

### DETAILED DESCRIPTION OF EMBODIMENTS

The present invention now will be described more fully hereinafter with reference to the accompanying drawings, in which preferred embodiments of the invention are shown.

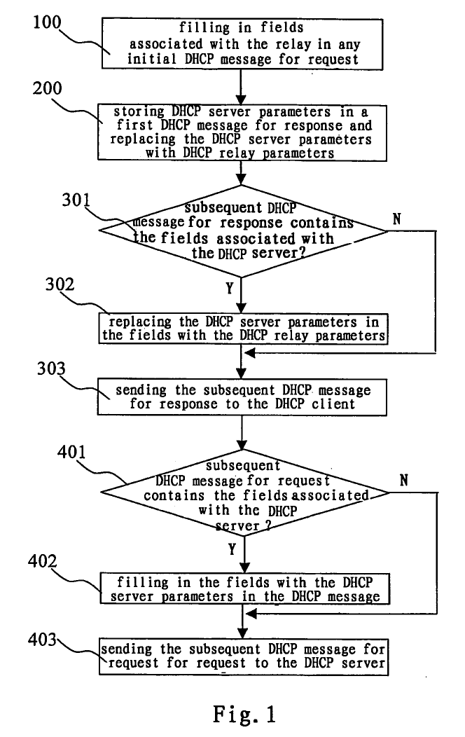

Referring to FIG. 1, the modifying of the fields in the DHCP message in the present invention comprises the following steps:

Step 100, after the DHCP relay receives any DHCP message for request sent from the DHCP client to the DHCP server, the DHCP relay fills in the fields associated with the DHCP relay in the initial DHCP message for request, so that any DHCP messages for response returned from the DHCP server to the DHCP client can pass through the DHCP relay.

Step 200, the DHCP relay receives the first DHCP message for response returned from the DHCP server to the DHCP client, then the DHCP relay extracts and stores the DHCP server parameters of the fields associated with the DHCP server in the first DHCP message for response, and the DHCP relay replaces the DHCP server parameters with its DHCP relay parameters and sending the first DHCP message for response to the DHCP client;

Step 301, the DHCP relay processes any received subsequent DHCP messages for response returned from the DHCP server to the DHCP client, and determines whether the subsequent DHCP messages for response contains the fields associated with the DHCP sever. If no, Step 303 is performed. If yes, Step 302 is performed.

Step 302, the DHCP relay parameters are used to replace the DHCP server parameters in the fields, so that any subsequent DHCP messages for request sent from the DHCP client to the DHCP server can pass through the DHCP relay.

Step 303, the subsequent DHCP messages for response is sending to the DHCP client.

Step 401, the DHCP relay processes the subsequent DHCP messages for request and determines whether the subsequent DHCP message for request contains the fields associated with the DHCP server. If no, Step 403 is performed. If yes, Step 402 is performed.

Step 402, the DHCP server parameters stored in Step 200 are written into the fields associated with the DHCP server, so that any subsequent DHCP messages for request can pass the validity checking by the DHCP server.

Step 403, the subsequent DHCP messages for response is sent to the DHCP server.

The unicast DHCP request sent from the DHCP client to the DHCP server is actually sent to the DHCP relay after the processing of Step 200 to Step 403.

In the subsequent processing, the broadband access device can control and manage the interaction between the DHCP user and the external DHCP server, vary the network parameters of the DHCP user and detect the DHCP user online according to the requirements of the user management strategy.

The processing described above can enable all of the DHCP interaction between the DHCP client and the external DHCP server, rather than only the broadcast packets sent from the DHCP client, to pass through the DHCP relay and meet the requirements of DHCP protocol. Also, it can enable the broadband access device to implement the control and management of the interaction between the DHCP client and the DHCP server.

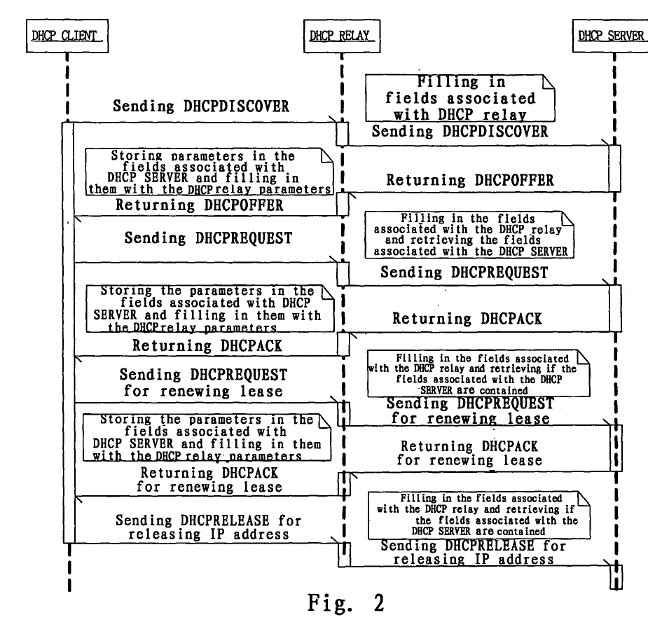

As shown in FIG. 2, it shows the time sequence diagram of the method according to the present invention. It can be seen from the figure that for DHCPDISCOVER message sent from the DHCP CLIENT (client) to the DHCP SERVER (server), the DHCP relay merely needs to fill in the fields associated with the DHCP relay with the values, so that the DHCP SERVER can return a response to the DHCP CLIENT to the DHCP relay. While receiving DHCPOFFER response returned from the DHCP SERVER to the DHCP CLIENT, the DHCP relay needs to store the values of the fields associated with the DHCP SERVER and replaces them with its DHCP relay parameters, so that the unicast request to the DHCP SERVER can be still sent to the DHCP relay after the DHCP CLIENT has configured IP address. In the following interaction, when receiving the DHCP message for request from the DHCP CLIENT, the DHCP relay needs to fill in the fields associated with the DHCP relay. Meanwhile, if the DHCP message contains the fields associated with the DHCP SERVER, the DHCP relay will fill in the fields with the previous stored values of the fields associated with the DHCP SERVER. Also, when the DHCP relay receives the DHCP message for response from the DHCP SERVER, if the DHCP message contains the fields associated with the DHCP SERVER, the DHCP relay needs to replace the values of the fields associated with the DHCP SERVER with its IP address.

The steps of the method of the present invention are described with combination of a wireless access system next. According to the requirements, the broadband access server needs to support an authentication mode based on DHCP+WEB PORTAL for broadband users. To simplify the management, ISP disposes a DHCP SERVER serving for assignment of IP address in the network. It is required that the users who requires WEB PORTAL as an access authentication mode can automatically obtain the properties of the network, such as IP address, by using the external DHCP SERVER. Therefore, the method of the present invention is applied when the DHCP RELAY module is developed in order to dynamically assign the IP address to the user at user side by the external DHCP SERVER and control/manage the interaction between the DHCP SERVER and the DHCP CLIENT on demand.

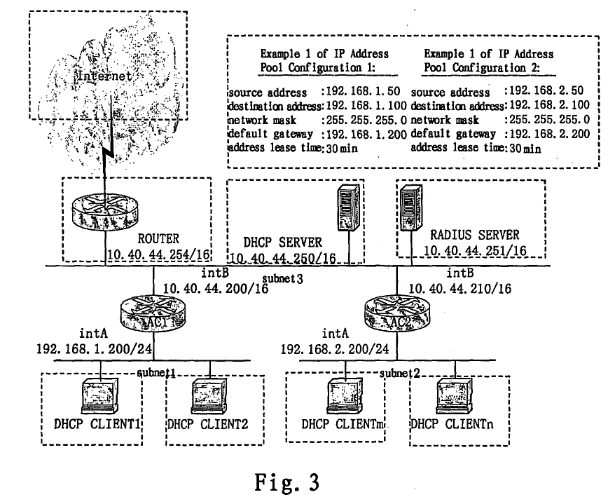

As shown in FIG. 3, it shows a diagram of an ISP access network. Two AC devices are used in FIG. 3, which are AC1 and AC2, to complete the access for the DHCP users. The number of AC devices is related to the number of users (FIG. 3 only shows one network structure including multiple AC devices). A RADIUS (Remote Authentication Dial In User Service) SERVER is used to authenticate and bill for the users. A DHCP SERVER is used to assign IP addresses to the DHCP users accessed by the two AC devices. And a router is used to access to Internet. In order to simplify the description of the steps in “the method of broadband access device for controlling and managing DHCP relay users”, the interaction between the DHCP CLIENT1 and the DHCP SERVER via AC1 is used as an example (other interactions between the DHCP CLIENT and the external DHCP SERVER via AC connected to the DHCP CLIENT are the same).

The processing steps of the method of the present invention implemented by AC1 are as bellows:

1) When the DHCP CLIENT1 initializes dynamic IP address lease, the DHCP CLIENT1 firstly sends DHCPDISCOVER message broadcast limitedly over the local area network. After receipt of DHCPDISCOVER message sent from the DHCP CLIENT1, the DHCP relay in AC1 device fills in the fields associated with the DHCP relay and sending DHCPDISCOVER message to the external DHCP SERVER.

2) The external DHCP SERVER sends DHCPOFFER message to the DHCP relay in the AC1 device after completing the processing. After receipt of the response message DHCPOFFER returned from the DHCP SERVER, the DHCP relay in the AC1 device extracts and stores the values of the fields associated with the DHCP SERVER and replaces the values of the fields associated with the DHCP SERVER with the parameters of the DHCP relay. And then, DHCPOFFER message is sent to the DHCP CLIENT1.

3) When receiving DHCPOFFER message, the DHCP CLIENT1 checks the network parameters and then sends DHCPREQUEST message broadcast limitedly over the local area network. After receipt of DHCPREQUEST message sent from the DHCP CLIENT1, the DHCP relay in AC1 device needs to fill in the fields associated with the DHCP relay. Meanwhile, if the DHCP message contains the fields associated with the DHCP SERVER, the values of the fields associated with the DHCP SERVER in the DHCP packet is replaced with the values of the fields associated with the DHCP SERVER stored in Step 2) to pass the validity checking by the DHCP SERVER. And then, DHCPREQUEST message is sent to the external DHCP SERVER.

4) When receiving DHCPREQUEST message, the external DHCP SERVER manages the assignment of IP address and then returns DHCPACK message to the DHCP relay in AC1 device. After receipt of DHCPACK message sent from the DHCP SERVER, the DHCP relay in AC1 device replaces the values of the fields associated with the DHCP SERVER with the parameters of the DHCP relay if the DHCP message contains the fields associated with the DHCP SERVER. And then, DHCPACK message is sent to the DHCP CLIENT1.

5) Before IP address configuration of the DHCP CLIENT1 is completed, when receiving the message such as DHCPREQUEST sent from the DHCP CLIENT1, the DHCP relay in AC1 device fills in the fields associated with the DHCP relay. Meanwhile, if the DHCP message contains the fields associated with the DHCP SERVER, the fields associated with the DHCP SERVER in the DHCP message is replaced with the values of the fields associated with the DHCP SERVER stored in Step 2) to pass the validity checking by the DHCP SERVER.

6) After the IP address configuration of the DHCP CLIENT1 is completed, when receiving DHCPREQUEST, DHCPINFORM or DHCPRELEASE message for renewing lease sent from the DHCP CLIENT1, the DHCP relay in AC1 device fills in the fields associated with the DHCP relay. After the IP address configuration is completed, if the DHCP message does not contain the fields associated with the DHCP SERVER, the fields associated with the DHCP SERVER does not need to be processed.

7) After the IP address configuration of the DHCP CLIENT1 is completed, when receiving the message for renewing lease such as DHCPACK sent from the DHCP SERVER, the DHCP relay in AC1 device needs to replace the values of the fields associated with the DHCP SERVER with the parameters of the DHCP relay if the DHCP message contains the fields associated with the DHCP SERVER. And then, DHCPACK message is sent to the DHCP CLIENT1.

8) As a result of the processing described above, all of the DHCP messages between the DHCP CLIENT1 and the external DHCP SERVER are able to pass through the DHCP relay in the AC1 device transparently so that the broadband access device can implement the control and management of the DHCP interaction between the DHCP CLIENT1 and the DHCP SERVER.

9) During the above described process, the DHCP relay in the broadband access AC1 device can control and manage the interaction between the DHCP user and the external DHCP SERVER, vary the network parameters of the DHCP user and detect the DHCP user online according to the requirements of user management strategy.

### INDUSTRIAL UTILITY

The technical effect of the present invention is that all of the DHCP messages interacted between the DHCP client and the DHCP server are enabled to pass through the DHCP relay by modifying the fields of the data packets sent from the DHCP client and the DHCP server, and it can be easily implemented to control and manage the interaction between the DHCP client and the external DHCP server, vary the network parameters of the DHCP user, detect the DHCP user online and the like according to the requirements of the user management strategy by controlling the DHCP relay. Furthermore, in the present invention, only Application Layer of TCP/IP protocol is needed to be processed to achieve the predetermined purpose of control/management. There is no difference from the ordinary network application layer software. It is not necessary for the present invention to modify the TCP/IP protocol stack or depend on the related Hook Function provided by the TCP/IP protocol stack.

1. A method of broadband access device for controlling a DHCP relay user to implement control and management of interaction between a DHCP client and a DHCP server, which comprises modifying protocol fields in all of DHCP messages interacted between a DHCP relay and the DHCP client and the DHCP server during initiation phase of the DHCP interaction at Application Layer of TCP/IP protocol, so that all of the DHCP messages interacted between the DHCP client and the DHCP server can pass through the DHCP relay.

2. The method of claim 1, wherein the modifying further comprises the following steps:
Step 1, after receiving any DHCP messages for request sent from the DHCP client to the DHCP server, the DHCP relay filling in fields associated with the DHCP relay in the DHCP message for request, so that any DHCP messages for response returned from the DHCP server to the DHCP client can pass through the DHCP relay;
Step 2, after receiving a first DHCP message for response returned from the DHCP server to the DHCP client, the DHCP relay extracting and storing DHCP server parameters of the fields associated with the DHCP server in the first DHCP message for response and then replacing the DHCP server parameters with DHCP relay parameters of the DHCP relay and sending the first DHCP message for response to the DHCP client;
Step 3, the relay processing any received subsequent DHCP messages for response returned from the DHCP server to the DHCP client, determining whether the subsequent DHCP messages for response contains the fields associated with the DHCP sever, if not, sending the subsequent DHCP messages for response to the DHCP client directly, otherwise, replacing the DHCP server parameters in the fields associated with the DHCP server with the DHCP relay parameters, and then sending the subsequent DHCP messages for response to the DHCP client so that any subsequent DHCP messages for request sent from the DHCP client to the DHCP server can pass through the DHCP relay;
Step 4, the DHCP relay processing the subsequent DHCP messages for request, determining whether the subsequent DHCP messages for request contains the fields associated with the DHCP sever, if no, sending the subsequent data packet for request to the DHCP server directly, otherwise, filling in the fields associated with the DHCP server with the DHCP server parameter stored in Step 2, and then sending the subsequent DHCP messages for request to the DHCP server so that any subsequent DHCP messages for request can pass validity checking by the DHCP server.

3. The method of claim 2, further comprising:
Step 5, the DHCP relay controlling and managing the interaction between the DHCP client and the DHCP server, varying network parameters of the DHCP client and detecting the DHCP client online according to requirements of user management strategy.

4. The method of claim 2, wherein in Step 1, for DHCPDISCOVER or DHCPREQUEST message sent from the DHCP client to the DHCP server, the DHCP relay fills in the fields associated with the DHCP relay with values so that DHCPOFFER, DHCPACK or DHCPNAK response from the DHCP server to the DHCP client can be sent to the DHCP relay.

5. The method of claim 4, wherein in Step 2, the DHCP relay receives DHCPOFFER, DHCPACK or DHCPNAK response, extracts and stores the DHCP server parameters in DHCPOFFER, DHCPACK or DHCPNAK response, and replaces the DHCP server parameters with the DHCP relay parameters so that a unicast request to the DHCP server can be still sent to the DHCP relay after the DHCP client has configured IP address.

6. The method of claim 4, wherein in Step 3, the DHCP relay receives the subsequent DHCP messages for response, and if the fields associated with the DHCP server are contained, the DHCP relay replaces the values of the fields associated with the DHCP server with its IP address.

7. The method of claim 6, wherein the subsequent DHCP messages for response is DHCPACK message in Dynamical Host Configuration Protocol.

8. The method of claim 6, wherein the subsequent DHCP messages for request is DHCPREQUEST message, DHCPINFORM message or DHCPRELEASE message in Dynamical Host Configuration Protocol.
